(19) United States
(12) Patent Application Publication
(10) Pub. No.: US 2012/0321974 A9
(43) Pub. Date: Dec. 20, 2012

(54) METHOD FOR CONTROLLING A FUEL CELL UTILIZING A FUEL CELL SENSOR

(75) Inventors: Aaron T. Crumm, Ann Arbor, MI (US); Timothy LaBreche, Ann Arbor, MI (US)

(73) Assignee: ADAPTIVE MATERIALS, INC., Ann Arbor, MI (US)

(21) Appl. No.: 12/870,191

(22) Filed: Aug. 27, 2010

Related U.S. Application Data
(63) Continuation of application No. 12/766,500, filed on Apr. 23, 2010.

(51) Int. Cl. H01M 8/10; H01M 8/24; H01M 8/06

(52) U.S. Cl. 429/423; 429/488; 429/466

(57) ABSTRACT

A solid oxide fuel cell module includes a fuel cell tube comprising an inner anode, an outer cathode, and an electrolyte disposed between the inner anode and the outer cathode. The inner anode includes a plurality of hollow rod current conducting members embedded in a bulk anode.

### FIELD OF THE DISCLOSURE

The disclosure relates to fuel cells and more particularly to current collectors for fuel cells.

### BACKGROUND

Fuel cells convert chemical energy to electrical energy, forcing electrons to travel through an electric circuit. The fuel cell includes two electrodes disposed on opposite sides of an electrolyte. The fuel cell includes an electrode configured to catalyze a reducing reaction and an electrode configured to catalyze an oxidizing reaction. The energy conversion efficiency of the fuel cell is related to the efficiency at which electrons are collected at electrodes and the efficiency at which electrons are transferred between the electrodes and other parts of the electric circuit. In addition to electrical conduction properties, the energy conversion efficiency of the fuel cell is also related to the pore structure of the electrode and the catalytic efficiency of the electrode. Therefore, optimizing energy conversion efficiency often requires optimizing competing properties of the fuel cell electrodes. For example, providing a pore structure having open pathways for fluid transfer to the electrolyte and having high levels of catalytic surface area can result in an electrode having low electrical conductivity. To assist with electrical current conduction, previous fuel cells have utilized internal current collectors comprising wires in contact with the internal surface of the active portion of the fuel cell tube. These internal current collectors can add weight and cost to the fuel cell tube and can lead to failure modes for the fuel cell as discussed below.

Previous fuel cells include current collectors welded to the fuel cell electrodes or mechanically forced against the fuel cell electrode, wherein the previous connections degrade over time causing electrical conduction losses over the operating life of the fuel cell. Harsh environmental conditions within the fuel cell have contributed to decoupling of previous current collectors and fuel cell electrodes. Mismatched coefficient of thermal expansion properties between the typically substantially metallic current collector and the ceramic-metallic electrode of the fuel cell tube can create opposing forces during thermal cycling. Further, the current collector experiences thermal stresses during operation due to a temperature gradient which can range from between 650-950 degrees Celsius at the active portion to several hundred degrees less at other areas of the current collector. Still further, wires of previous current collectors disposed within fluid flow paths experience displacement forces from the high fluid flow rates and create high pressure drop levels within the fuel cell tube.

Therefore, fuel cells with improved current collection and conduction components are needed.

### SUMMARY

A solid oxide fuel cell module includes a fuel cell tube defining a fuel cell tube inner chamber. The fuel cell tube includes a fuel cell tube inlet, a fuel cell tube outlet, an active portion, and an inner current carrier. Oxidizing fluid and reducing fluid react with the active portion to generate an electromotive force. The active portion includes an inner electrode; an outer electrode; and an electrolyte disposed between the inner electrode and the outer electrode. The inner current carrier is disposed between the tube inlet and the active portion. The inner current carrier has a temperature gradient when the active portion is at an active portion steady-state operating temperature. The solid oxide fuel cell module further includes a fuel feed tube routing fuel through the fuel cell tube inlet to the fuel cell tube inner chamber. The solid oxide fuel cell module further includes an anode current collector electrically connected to the inner current carrier between the active portion and the fuel cell tube inlet.

### DESCRIPTION OF THE FIGURES

FIG. 1 is a cross-sectional view of a fuel cell stack in accordance with an exemplary embodiment of the present disclosure;

FIG. 2 is an exploded perspective view of a portion of the fuel cell stack of FIG. 1;

FIG. 3 is a perspective view of the portion of the fuel cell stack of FIG. 2;

FIG. 4 is a cross-sectional view of a fuel cell tube and a cathode current collector in accordance with a first exemplary embodiment of the present disclosure;

FIG. 5 is a cross-sectional view of a fuel cell tube and a cathode current collector in accordance with a second exemplary embodiment of the present disclosure; and

FIG. 6 is a cross-sectional view of a fuel cell stack in accordance with an exemplary embodiment of the present disclosure;

It should be understood that the appended drawings are not necessarily to scale, presenting a somewhat simplified representation of various preferred features illustrative of the basic principles of the invention. The specific design features of the fuel cell as disclosed herein will be determined in part by the particular intended application and use environment. Certain features of the illustrated embodiments have been enlarged or distorted relative to others for visualization and clear explanation. In particular, thin features may be thickened, for example, for clarity of illustration.

### DETAILED DESCRIPTION

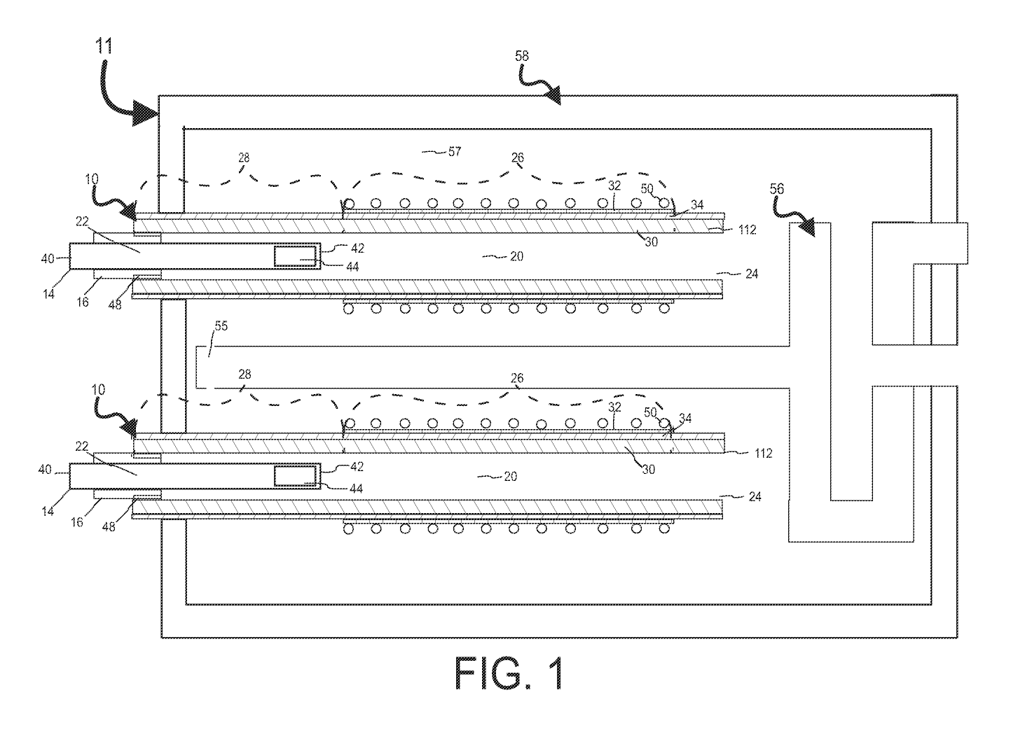

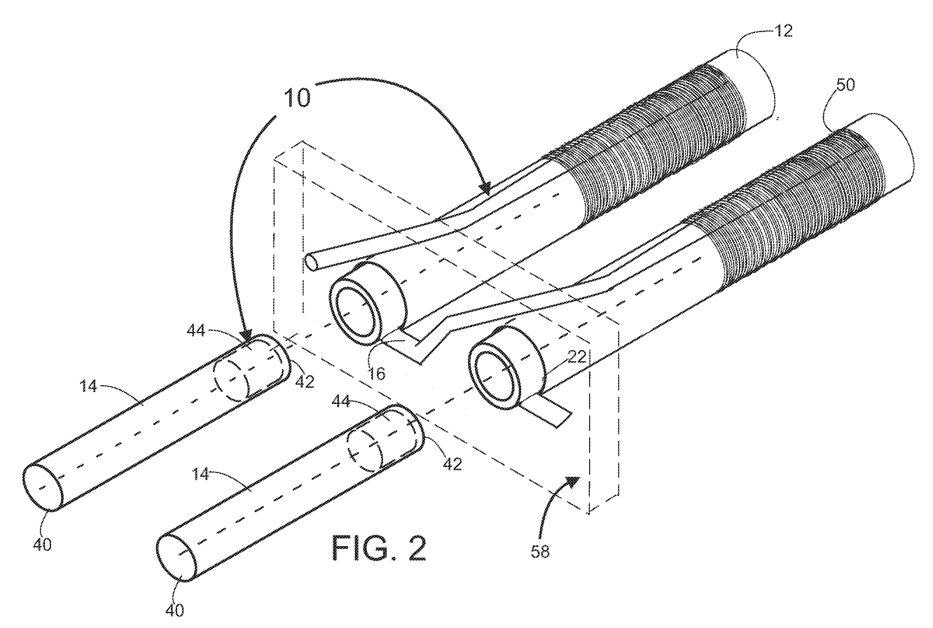

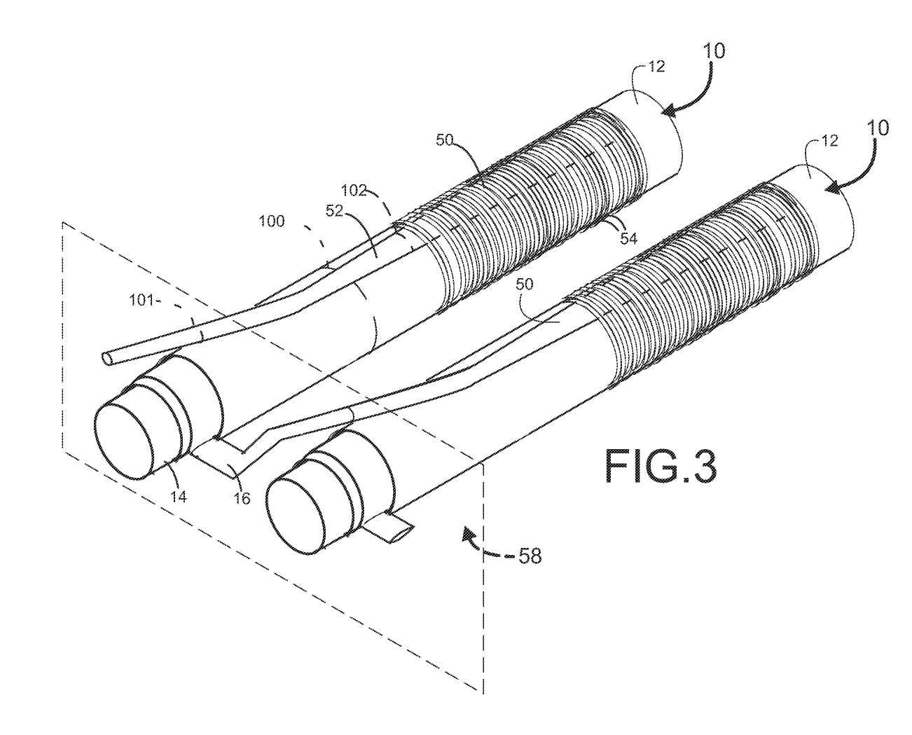

Referring to the figures, wherein exemplary embodiments are described and wherein like elements are numbered alike, FIGS. 1-3 depict various views of an exemplary fuel cell stack 11 including fuel cell tube modules 10 in which fuel cell tubes 12 are electrically interconnected and in which substantially all the electric current conducted between each individual fuel cell tube 12 is conducted through an inner current carrier 28 between an active portion 26 and a fuel cell tube inlet 22. Although two fuel cell tube modules are shown in the cross sectional depiction of FIGS. 1-3, fuel cell stacks can be configured to operate with several different tube quantities (e.g., one to several thousand) and configurations and exemplary tubular stack configurations described herein should be understood as not limiting on the scope of the disclosure. The fuel cell stack 11 further includes insulated walls 58 defining an insulated chamber 57, and a recuperator 56.

The fuel cell tube modules 10 are configured to input raw fuel, convert raw fuel to reformed fuel, and generate electricity by electrochemical reactions with reformed fuel and oxidizing fluid. The fuel cell modules 10 each includes fuel cell tube 12, a fuel feed tube 14, an internal reformer 44, an anode current collector 16, and a cathode current collector 50.

The fuel cell tube 12 defines a fuel cell tube inner chamber 20 disposed between a fuel cell tube inlet 22 and a fuel cell tube outlet 24. The terms “inlet” and “outlet” are used in the specification with reference to the general fluid flow direction within each fuel cell tube module 10 of the fuel cell stack 11. Thus, when referring to fuel cell tube 12, fuel (i.e. raw fuel) and air enter the fuel cell tube through the fuel cell inlet 22 and exhaust fluid (i.e. reacted fuel, water vapor, and unutilized air) exits the fuel cell tube through the fuel cell tube outlet 24. The terms upstream and downstream are used in the specification to designate the position of a first fuel cell stack component to a second fuel cell stack component with reference to the general fluid flow direction within the fuel cell stack 11.

Further, as used herein, the term “tube” refers to any structure generally configured to direct fluid. Although the exemplary fuel cell tube comprises a continuously enclosed circular cross-section, in an alternate embodiment, alternate geometries can be utilized and the cross-section does not have to be fully enclosed. Exemplary alternate geometries include polygonal shapes, for example rectangular shapes, and other ovular shapes.

Each fuel cell tube 12 includes an active portion 26 and an inner current carrier 28. The active portion 26 refers to the portion of the fuel cell tube generating electromotive force and the active portion 26 includes an anode layer 30, an electrolyte layer 34, and a cathode layer 32, and can further include other layers to provide selected electrical, electrochemical and catalytic properties.

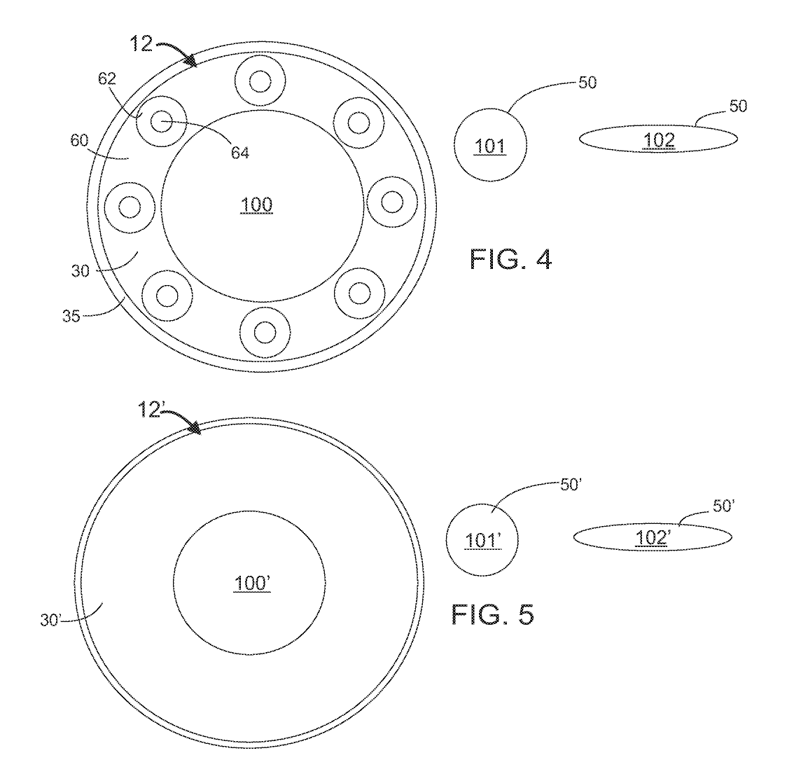

The anode layer 30 comprises an electrically and ionically conductive ceramic-metallic material that is chemically stable in a reducing environment. In one exemplary embodiment, the anode layer 30 is a porous structure comprising a conductive metal such as nickel, disposed in a ceramic skeleton, such as yttria-stabilized zirconia. In one exemplary embodiment, the anode layer 30 comprises conductive rods primarily configured for lengthwise electrical conduction. Exemplary anode layer materials will be discussed in further detail below with reference to FIGS. 4-5.

The electrolyte layer 34 is a typically dense layer configured to conduct ions between the anode layer 30 and the cathode layer 32. The exemplary electrolyte layer 34 can include lanthanum-based materials, zirconium-based materials and cerium-based materials such as lanthanum strontium gallium manganite, yttria-stabilized zirconia and gadolinium doped ceria, and the electrolyte layer 34 can further include various other dopants and modifiers to affect ion conducting properties.

The cathode layer 32 comprises an electrically conductive material that is chemically stable in an oxidizing environment. In an exemplary embodiment, the cathode layer 32 comprises a perovskite material and specifically comprises lanthanum strontium cobalt ferrite (LSCF).

An outer current collector 50 is disposed in electrical contact with the cathode layer 32. The outer current collector 50 includes a longitudinal portion 52 and an axial portion 54. The longitudinal portion 52 is a tapered wire such that a first cross section 101 has a substantially circular shape and a second cross section 102 has a flattened shape. The axial portion 54 comprises one or more wires wrapped around the outer circumference of the fuel cell tube 12. The substantially circular cross-section 101 can support ease of manufacture as the circular wire can be easily fed through round holes in insulated walls 58 and the holes can be sealed. The flattened cross-section allows for high surface area contact with the fuel cell electrode thereby supporting low resistance current transfer. The exemplary outer current collector can be formed by drawing a wire precursor to a selected diameter and subsequently flattening a portion of the wire under mechanical force. In exemplary embodiment, current carrier wire comprises silver, however, in alternate embodiments other materials capable of conducting current in high temperature oxidative environments can be used.

The inner current carrier 28 refers to the portion of the fuel cell tube extending from the active portion 26 toward the inlet end 22 of the fuel cell tube 12. In an exemplary embodiment, the inner current carrier 28 comprises the anode layer 30 and the electrolyte layer 34, wherein the anode layer 30 and the electrolyte layer 34 have a substantially continuous cross-section throughout the length of the fuel cell tube 12. However, unlike the active portion 26, the inner current carrier 28 is substantially uninvolved in the electrochemical reactions and the inner current carrier 28 is provided to route current along the length of the fuel cell tube's longitudinal axis between the active portion 26 and the inlet end 22 of the fuel cell tube 12.

During operation a temperature gradient is generated across the inner current carrier 28, wherein the portion of the inner current carrier 28 contacting the active portion 26 is above 600 degrees Celsius and more particular above 700 degrees Celsius and the temperature drop across the length of the inner current carrier 28 is more than 200 degrees Celsius and more particularly more than 400 degrees Celsius. Thus, the temperature of the inner current carrier 28 proximate the inlet end 22 of the fuel cell tube 12 is sufficiently low such that low temperature joining material and low temperature joining methods can be utilized to electrically couple the anode current collector 16 to the inner current carrier 28.

The anode current collector 16 is coupled to a low temperature portion of the inner current carrier 28 such that electricity can be transferred between the anode current collector 16 and the inner current carrier 28. “Low temperature portion, as used herein refers to a portion of the anode current collector that has a substantially lower temperature (i.e., at least 200 degrees Celsius lower) than the highest temperature location of the inner current carrier 28 (i.e., the portion proximate the active portion 26 of the fuel cell tube 12.)

The anode current collector 16 comprises material generally configured to conduct electrons between inner current carrier 28 and electrical connections outside the fuel cell tube 12. In one embodiment the anode current collector 16 comprises copper, and can comprise features for electrically connecting and mechanically fastening the fuel cell tube to a flow distribution portion (not shown) and a power routing portion (not shown) of the fuel cell stack 11. The anode current collector 16 comprises a metal tubular formed and can include features to provide desired locating and tolerancing characteristics to enhance connection with the fuel cell tube 12.

A joining element 48 is configured to bond the inner current carrier 28 to the anode current collector 16. In one exemplary embodiment, the joining element comprises a welded joint. In one exemplary embodiment, the inner current carrier 28 comprises a braze alloy 24 configured for compatibility with the inner current carrier 28 and the anode current collector 16. Exemplary materials for the braze alloy include copper, nickel, and like metals. In an alternate embodiment, the joining element comprises a conductive epoxy material. In one embodiment, the conductive epoxy resin includes silver particles. In one embodiment, the conductive epoxy comprises one or more other conductive materials such as carbon, graphite, copper and like materials. In one embodiment, the joining element can comprise solder. In one embodiment, the anode current collector is mechanically forced against the anode or otherwise joined to the anode without utilizing a separate bonding material.

The fuel feed tube 14 comprises a fuel feed tube inlet 40 and a fuel feed tube outlet 42 and the fuel feed tube 14 has an internal reformer 44 disposed therein. The fuel feed tube 14 comprises a dense ceramic material compatible with the high operating temperatures within the insulated chamber 57, for example, an alumina based material or a zirconia based material. In an exemplary embodiment, the reformer 44 includes a supported metallic catalyst material having a metal alloy comprising, for example platinum, palladium, rhodium, iridium, or osmium disposed on a ceramic substrate such as an alumina substrate or a zirconia substrate, wherein the ceramic substrate is disposed within the fuel feed tube 14. In particular, the reformer 44 can be substantially similar to that described in further detail in U.S. Pat. No. 7,547,484 entitled “Solid Oxide Fuel Cell Tube With Internal Fuel Processing”, the entire contents of which is hereby incorporated by reference herein. Fuel can be routed through the reformer 44 such that substantially no unreformed fuel contacts the anode portion 30 of the fuel cell tube 12.

The recuperator 56 is provided to transfer heat between fuel cell exhaust and a cathode air input stream entering the insulated chamber 57. In an exemplary embodiment, the recuperator 56 comprises a multi-stage, stainless steel heat exchanger compatible with the operating temperatures and environment in the insulated chamber 57.

The insulated walls 58 thermally insulate the active portions 26 of the fuel cell modules 10 to maintain a desired operating temperature. The insulated walls 58 can comprise ceramic-based material tolerant of high temperature operation, for example, foam, aero-gel, mat-materials, and fibers formed from, for example, alumina, silica, and like materials.

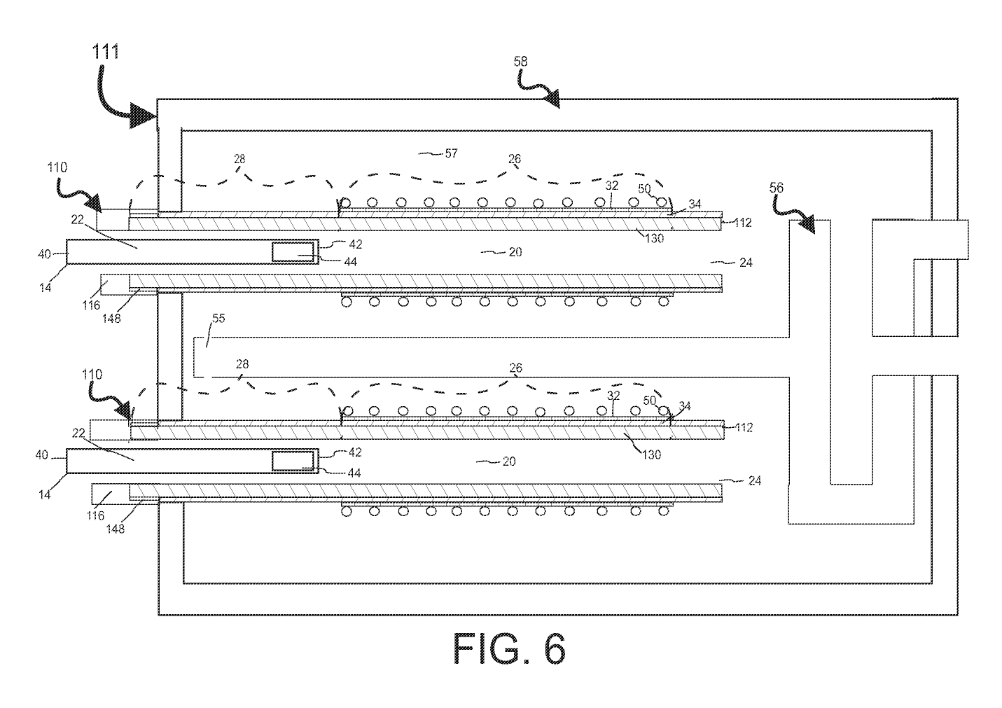

Referring to FIG. 6 in an alternate embodiment, a fuel cell stack 111, comprises a fuel cell module 110 comprising an anode current collector 116 electrically connected to an outer surface of an exposed anode layer 130 of a fuel cell tube 112 and abutting an end of the fuel cell tube 112. In an exemplary embodiment, the anode current collector is electrically connected to the outer surface of the exposed anode layer 130 utilizing a joining member 148. The joining member 148 can comprise substantially similar materials to the joining member 48. The electrolyte layer 134 can be removed from a portion of the anode layer 30 or can be selectively deposited on the anode layer 130 utilizing methods that will be readily apparent to one of ordinary skill of the art. Further, one of ordinary skill in the art will recognize from the present disclosure that several methods can be utilized to locate, position and secure anode current collectors on the fuel cell tube 10 and the design can be adapted for manufacturability and optimal performance.

Referring to FIG. 4 the cross sections of the cathode current collector 50 and the inner current carrier 26 are tailored to provide desired electrical conductance properties. Electrical conductance is defined in equation 1 below:

$$G = \frac{σ A}{l} \qquad ( 1 )$$

wherein G is electrical conductance;
σ is conductivity;
A is unit area; and
l is a unit length.

The average conductivity over a cross-sectional area of the cathode current collector 50 is higher than the average conductivity over a cross-sectional area of the inner current carrier 26. Therefore, for a given unit length, the unit area of the inner current carrier 26 must be higher to provide substantially similar electrical conductance. Substantially similar electrical conductance refers to an electrical conductance of the inner current carrier 28 that is within 25% and more particularly within 10% of each of the cross sections 101 and 102. In particular, the inner current carrier 28 has a cross-sectional area that is equal to about one tenth to one twentieth of each areas of the cross sections 101, 102 of the cathode current collector 50, wherein this cross-sectional area ratio tailors the inner current carrier 28 and the cathode current collector 50 for substantially equivalent conductance at operating conditions.

The inner current carrier 28 comprises the electrolyte layer 34 acting as a fluid barrier, an anode layer 30 comprising bulk anode 60 and rods 62 having holes 64 disposed therethrough. The exemplary bulk anode 60 comprises yttria stabilized zirconia and nickel and comprises a porous structure that allows fluid transport therethrough. In particular, the bulk anode 60 is tailored for anode reactions within the fuel cell tube 12. The exemplary conductive rods 62 have holes 64 disposed therethrough. In alternate embodiments, the rods can be solid structures disposed within the bulk anode 60.

The exemplary conductive rods 62 have a substantially higher nickel-to-yttria-stabilized zirconia ratio than the bulk anode 60. Further, the exemplary conductive rods 62 have a lower porosity level and higher density level than the bulk anode 60. Therefore, the conductive rods 62 include materials that provide higher longitudinal conductivity than the bulk anode 60. In alternate embodiments, the fuel cell tube 12 can include other conducting members comprising for example, copper, silver, gold, and like materials.

As used herein the term “rod” refers to any structure generally configured to direct electricity in directions substantially parallel to a length of the fuel cell tube 12. Although the exemplary electrically conductive rods 62 have a continuously circular cross-section, in alternate embodiments, alternate geometries can be utilized and the cross-section does not have to be fully enclosed. Exemplary alternate geometries include other ovular shapes, and polygonal shapes, for example rectangular shapes.

Although the exemplary electrolyte layer 34 is continuous and is a constituent of both the fuel cell active portion 26 and the inner current carrier 28, the electrolyte layer 34 does not act as an ion conductor within the inner current carrier 28. In alternate embodiments, the inner current carrier can comprise an outer fluid barrier in addition to or instead of the electrolyte layer 34 that has a different composition than the electrolyte layer 34. Likewise the exemplary anode 30 is continuous and is a constituent of both the fuel cell active portion 26 and the inner current carrier 28 In alternate embodiments the inner current carrier 28 can comprise a different current carrying structure such as a structure tailored for higher current conduction than the active portion 26.

Referring to FIG. 5, in an alternate embodiment, an inner current carrier 28′ comprising bulk anode without containing current conducting rods can be utilized instead of the current carrier 28. During operation, the conductance of the cross section 100′ of the inner current carrier 28′ is substantially similar to the electrical conductance through each of the cross section 101′ and the cross section 102′ of an anode current collector. The substantially similar electrical conductance refers to an electrical conductance of the inner current carrier 28′ that is within 25% and more particularly within 10% of that each of the cross sections 101′ and 102′. In particular, the inner current carrier 28′ has a cross-sectional area that is equal to about one twentieth to one thirtieth of each cross sectional area 101′, 102′ of the cathode current collector 50′, wherein this cross-sectional area ratio tailors the inner current carrier 28′ and the cathode current collector 50′ for substantially equivalent conductance.

Each of the fuel cell tubes 12, 12′ can be manufactured utilizing a co-extrusion process as described in exemplary U.S. Pat. No. 6,749,799 entitled “Method for Preparation of Solid State Electrochemical Device”. The rods 62 can be formed by removing material from a bulk anode feed rod (that is bulk material prior to extrusion) forming holes (not shown) and subsequently inserting an a precursor material to the rods 62 into the holes. The holes 64 within the rods 62 can be formed by removing material from the rods 62 or by utilizing fugitive material or holes within the precursor material to the rods 62. By utilizing rods comprising an inner fugitive material, the rods will adhere to the bulk anode 60 during sintering thereby increasing electrical contact and durability of the fuel cell system allowing shrinkage wherein the outer surface of the rods 62 will comply with the inner surface of the bulk anode 60.

In alternate embodiments, other processes such as single layer extrusion, spray forming, casting and screen-printing can be utilized in the manufacture the fuel cell tube.

The fuel cell stack 11 has several cost and durability improvements over previous fuel cell stacks. The fuel cell stack 11 is configured for manufacturing by high volume processes. The fuel cell stack 11 allows current to travel through the low temperature portions of the fuel cell stack 11 providing short conduction paths, low cost materials, and low cost sealing methods. Further, by providing short conduction paths to low temperature portions of the fuel cell stack 11, the fuel cell stack 11 can efficiently utilize low temperature diodes for creating circuits bypassing fuel cell tubes 10.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A solid oxide fuel cell module comprising:
a fuel cell tube comprising an inner anode, an outer cathode, and an electrolyte disposed between the inner anode and the outer cathode, wherein the inner anode includes a plurality of hollow rod current conducting members embedded in a bulk anode.

2. The solid oxide fuel cell module of claim 1, wherein the hollow rod current conducting members have a higher electrical conductivity level than the bulk anode.

3. The solid oxide fuel cell module of claim 1, wherein the bulk anode comprises nickel and wherein the hollow rod current conducting members comprise nickel at a higher nickel concentration than the bulk anode.

4. The solid oxide fuel cell module of claim 1, wherein the fuel cell tube and the hollow rod current conducting members are formed by extrusion.

5. The solid oxide fuel cell module of claim 1, wherein the hollow rod current conducting members are cylindrical.

6. The solid oxide fuel cell module of claim 1, further including an internal fuel reforming member disposed inside the fuel cell tube.

7. The solid oxide fuel cell module of claim 1, further including a fuel feed tube configured to route raw fuel to the internal fuel reforming member.

8. The solid oxide fuel cell module of claim 1, further including a current carrier configured to collect and conduct current at an inner surface of the anode.

9. A solid oxide fuel cell module comprising:
a fuel cell tube comprising an inner electrode; an outer electrode; and an electrolyte disposed between the inner electrode and the outer electrode, wherein at least one of the inner electrode and the outer electrode comprises a rod current conducting member embedded inside a bulk electrode.

10. The solid oxide fuel cell module of claim 9, wherein the rod current conducting member is a hollow rod current conducting member.

11. The solid oxide of fuel cell module of claim 9, wherein the rod current conducting member is cylindrical.

12. The solid oxide fuel cell of module of claim 9, further comprising a plurality of rod current conducting members embedded in a bulk anode.

13. The solid oxide fuel cell module of claim 9, wherein the rod current conducting member is embedded in a bulk anode.

14. The solid oxide fuel cell module of claim 13, wherein the rod current conducting member comprises nickel and wherein the rod current conducting member comprises a higher nickel concentration level than the bulk anode.

15. The solid oxide fuel cell module of claim 9, wherein the fuel cell tube comprises a fuel cell tube inlet and a fuel cell tube outlet.

16. The solid oxide fuel cell module of claim 9, wherein the rod current conducting member is disposed throughout a length of the fuel cell tube.

17. A solid oxide fuel cell stack comprising a plurality of solid oxide fuel cell tubes electrically interconnected, each tube comprising:
a fuel cell tube comprising an inner anode, an outer cathode, and an electrolyte disposed between the inner anode and the outer cathode, wherein the anode has a plurality of hollow rod current conducting members embedded in a bulk anode.

18. The solid oxide fuel cell stack of claim 17, wherein each fuel cell tube further comprises an internal reformer disposed inside the fuel cell tube.

19. The solid oxide fuel cell stack of claim 17, the anode comprises nickel and ytteria stabilized zirconia and wherein the current conducting rod comprises nickel at a higher nickel concentration level than the bulk anode nickel concentration level.

20. The solid oxide fuel cell stack of claim 19, wherein the hollow rod current conducting members has a lower porosity level than the bulk anode porosity level.
